(19) United States
(12) Patent Application Publication
(10) Pub. No.: US 2026/0290027 A1
(43) Pub. Date: Sep. 24, 2026

(54) MONITORING SYSTEM AND MONITORING METHOD

(71) Applicant: Panasonic Intellectual Property Management Co., Ltd., Osaka (JP)

(72) Inventor: Katsunori DAIMO, Osaka (JP)

(21) Appl. No.: 19/678,424

(22) Filed: May 15, 2026

Related U.S. Application Data
(63) Continuation of application No. PCT/JP2024/037935, filed on Oct. 24, 2024.

(30) Foreign Application Priority Data
Nov. 21, 2023 (JP) 2023-197616

(51) Int. Cl. G06V 20/52; G06V 40/20

(52) U.S. Cl. CPC G06V 20/52; G06V 40/20

(57) ABSTRACT

A monitoring system monitors, with at least one camera, a work process including a plurality of processes performed on an object. The monitoring system includes: an image acquisition circuit that acquires image data indicating each of a plurality of monitoring images obtained by capturing the plurality of processes with the at least one camera; and a controller that executes image recognition processing to recognize a status of each process in the work process based on the image data. The controller selects a monitoring image as an input for the image recognition processing from among the plurality of monitoring images based on sensor information indicating a detection result of the object in the work process, and executes the image recognition processing on the selected monitoring image from among the plurality of monitoring images without executing the image recognition processing on an unselected monitoring image from among the plurality of monitoring images.

### TECHNICAL FIELD

The present disclosure relates to a monitoring system and a monitoring method for monitoring, with at least one camera, a work process including a plurality of steps performed on an object.

### BACKGROUND ART

JP 2019-016161 A discloses an image processing apparatus that can reduce the overall computation amount while suppressing a drop in accuracy of processing a specific object among a plurality of objects, in image processing using images from a plurality of imaging units. In image processing for generating a three-dimensional model of an object to be processed, the image processing apparatus uses, for the specific object, images captured by more imaging units than imaging units for other objects, which is set in response to a user operation among the plurality of objects. As a result, the image processing apparatus suppresses a drop in accuracy of the three-dimensional model for the specific object designated by the user.

### Patent Documents

Patent Document 1: JP 2019-016161 A

### SUMMARY

The present disclosure provides a monitoring system and a monitoring method capable of reducing processing load in monitoring a work process with at least one camera.

A monitoring system according to one aspect of the present disclosure monitors, with at least one camera, a work process including a plurality of processes performed on an object. The monitoring system includes an image acquisition circuit and a controller. The image acquisition circuit acquires image data indicating each of a plurality of monitoring images obtained by capturing the plurality of steps with the at least one camera. The controller executes image recognition processing to recognize a status of each process in the work process based on the image data. The controller selects a monitoring image as an input for the image recognition processing from among the plurality of monitoring images based on sensor information indicating a detection result of the object in the work process. The controller executes the image recognition processing on a selected monitoring image from among the plurality of monitoring images without executing the image recognition processing on an unselected monitoring image from among the plurality of monitoring images.

These general and specific aspects may be realized by a system, a method, and a computer program, and a combination thereof.

According to the monitoring system and the monitoring method of the present disclosure, it is possible to reduce processing load in monitoring a work process with at least one camera.

### BRIEF DESCRIPTION OF DRAWINGS

FIG. 1 is a diagram illustrating an overview of a site monitoring system according to a first embodiment;

FIG. 2 is a block diagram illustrating a configuration of a site monitoring PC in the site monitoring system;

FIG. 3 is a block diagram illustrating a configuration of an analysis PC in the site monitoring system;

FIG. 4 is a diagram for describing a disposition of a camera in the site monitoring system;

FIG. 5 is a diagram for describing a disposition of sensors in the site monitoring system;

FIG. 6 is a diagram for describing a bottleneck determined in the site monitoring system;

FIG. 7 is a flowchart illustrating an operation of the site monitoring PC in the first embodiment;

FIGS. 8A to 8C are diagrams for describing image recognition processing in the site monitoring PC;

FIG. 9 is a diagram for describing bottleneck determination information in the site monitoring PC;

FIG. 10 is a diagram for describing calculation processing of a delay index in the site monitoring PC;

FIG. 11 is a diagram for describing an analysis screen in the site monitoring system of the first embodiment;

FIG. 12 is a diagram for describing an operation of the site monitoring PC in a modification of the first embodiment; and

FIG. 13 is a diagram for describing an analysis screen in the site monitoring system according to the modification of the first embodiment.

### DETAILED DESCRIPTION

Hereinafter, embodiments will be described in detail with reference to the drawings as appropriate. Unnecessarily detailed description may be omitted. For example, a detailed description of a well-known matter and a repeated description of substantially the same configuration may be omitted. This is to avoid unnecessary redundancy of the following description and to facilitate understanding of the skilled person. The accompanying drawings and the following description are provided by the inventor(s) for the skilled person to fully understand the present disclosure, and they are not intended to limit the subject matter described in the claims.

### First Embodiment

### 1. Configuration

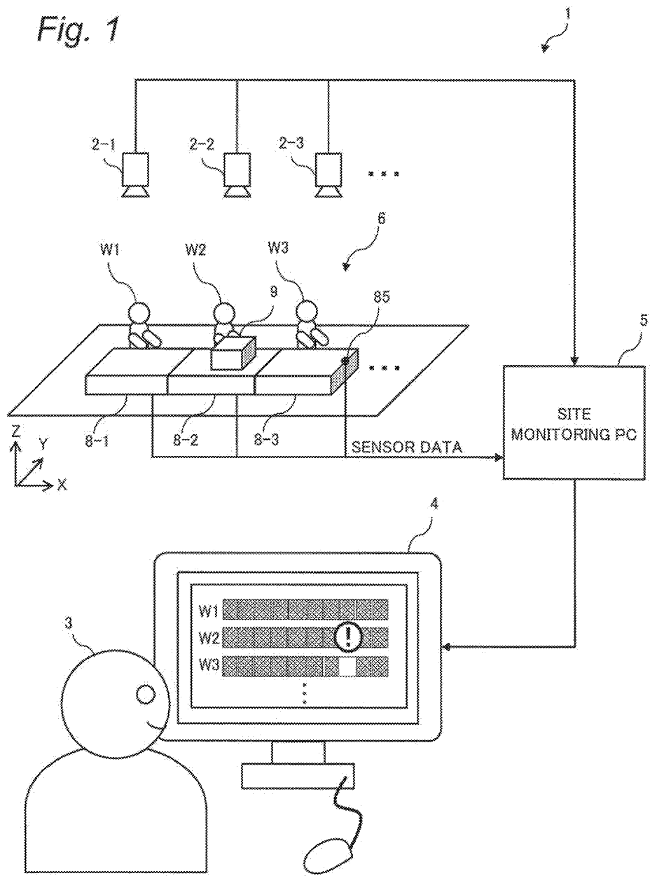

A site monitoring system according to a first embodiment as an example of a monitoring system in the present disclosure will be described with reference to FIG. 1. FIG. 1 is a diagram illustrating an overview of a site monitoring system 1 according to the present embodiment.

### 1-1. System Overview

As illustrated in FIG. 1 for example, the site monitoring system 1 according to the present embodiment includes a plurality of cameras 2-1, 2-2, and 2-3, a site monitoring PC 5, and one or more sensors 85. The present system 1 is used for an application for monitoring processes of work performed by a plurality of workers W1, W2, and W3 at a site 6 such as a factory to analyze work efficiency or the like of each of the workers W1 to W3. The present system 1 further includes an analysis PC 4 that provides an analysis screen or the like used for analysis, to a user 3 such as a manager of the site 6 or a person in charge of analysis. Further, in the present system 1, sensor data output from each sensor 85 installed at the site 6 is transmitted to the site monitoring PC 5.

In the site 6 of FIG. 1, a plurality of cells 8-1, 8-2, and 8-3 and the like are continuously disposed as work areas where the workers W1, W2, and W3 work, respectively, and work such as manufacturing of a product 9 is performed. For example, in each of the cells 8-1 to 8-3, a plurality of processes in the work for each product 9 is sequentially performed, and the product 9 is sent to a cell corresponding to the next process in response to completion of one process. In the present embodiment, the product 9 is an example of an object to which the plurality of processes are performed in the work as an example of a work process.

The cameras 2-1, 2-2, and 2-3 of the present embodiment, respectively corresponding to the cells 8-1, 8-2, and 8-3, are each disposed to capture an image of a range in which the corresponding process is performed in each cell at the site 6. Hereinafter, the cameras 2-1 to 2-3 are also collectively referred to as a camera 2. The cells 8-1 to 8-3 are also collectively referred to as a cell 8, and the workers W1 to W3 are also collectively referred to as a worker W. The present system 1 and the site 6 are not limited to an example illustrated in FIG. 1, the number of the cameras 2 may be four or more, and the number of the cells 8 may be four or more. The images of the respective cells 8 captured by the cameras 2 are an example of a plurality of monitoring images in the present embodiment.

The camera 2 of the present system 1 repeats an image capturing operation at a predetermined cycle at the site 6, for example, and generates image data indicating a captured image obtained at each cycle. The camera 2 is connected to the site monitoring PC 5 so that the image data is transmitted to the site monitoring PC 5, for example.

In the site monitoring PC 5 of the present system 1, various types of information used for analysis of work efficiency or the like of the worker W in each process are output to the analysis PC 4, performing processing such as image recognition to recognize a progress status of each process in each cell 8 in the work based on the image data obtained from each camera 2. The progress status of each step is an example of a status of each process in the present embodiment. For example, the user 3 can analyze, from the information output from the analysis PC 4, a process of a bottleneck as a starting point of delay of the work, the bottleneck causing the process and following processes to be delayed depending on the progress status of such a bottleneck process performed by the worker W in the specific cell 8. Further, in the present system 1, the user 3 can analyze the image of each cell 8 captured by each camera 2 to study a factor of the bottleneck and the like.

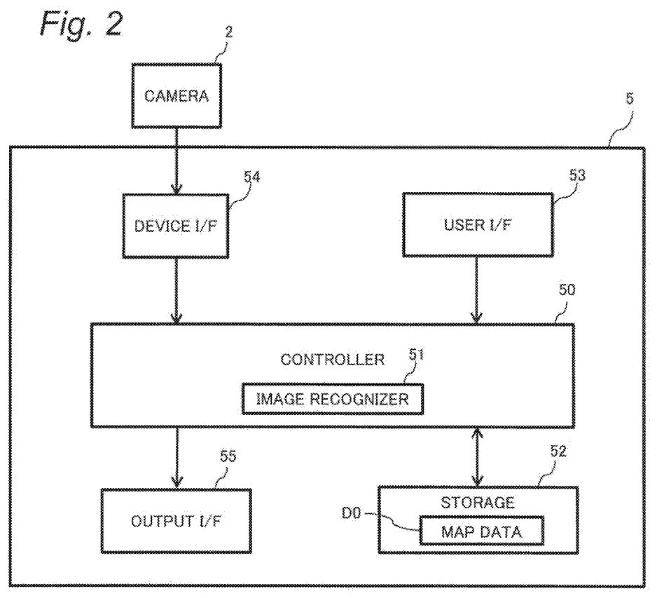

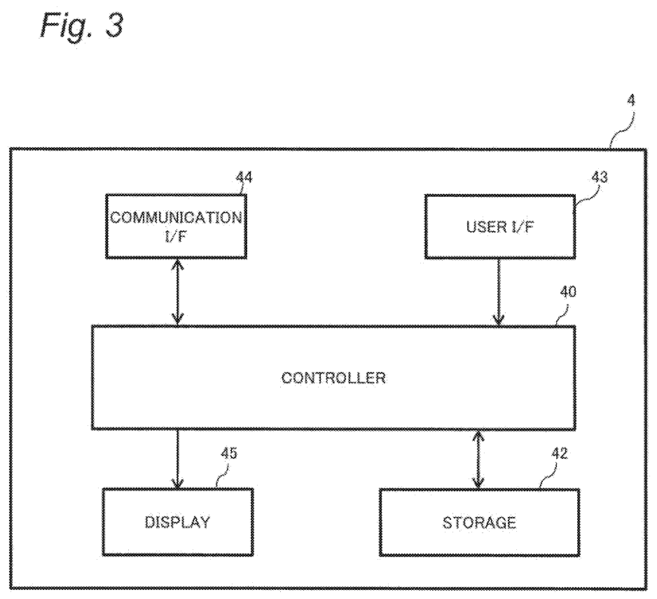

The site monitoring PC 5 and the analysis PC 4 of the present system 1 are each constituted by a personal computer (PC) as an example of an information processing apparatus. Hereinafter, configurations of the site monitoring PC 5 and the analysis PC 4 will be described below with reference to FIGS. 2 and 3, respectively.

### 1-2. Configuration of Site Monitoring PC

FIG. 2 is a block diagram illustrating a configuration of the site monitoring PC 5. The site monitoring PC 5 in FIG. 2 includes a controller 50, a storage 52, a user interface 53, a device interface 54, and an output interface 55. Hereinafter, the interfaces are abbreviated as “I/F”.

The controller 50 includes, for example, a CPU or an MPU that realizes a predetermined function in cooperation with software, and controls the overall operation of the site monitoring PC 5. The controller 50 reads data and programs stored in the storage 52, performs various types of arithmetic processing, to realize various functions.

For example, the controller 50 executes a program including a command group for realizing functions of the site monitoring PC 5. The above-described program may be provided from a communication network such as the Internet, or may be stored in a portable recording medium. The controller 50 may include an internal memory as a temporary storage area that holds various types of data and programs.

The controller 50 of the present embodiment includes an image recognizer 51 as a functional configuration that functions in cooperation with software. Based on the image data, the image recognizer 51 recognizes the progress status in which the process of the work is performed in an area appearing in the image indicated by the image data. For example, the progress status is recognized as a behavior state of the worker W who performs the work. For example, the image recognizer 51 outputs a category corresponding to the progress status of the process captured in an input image to the image recognizer 51, among a plurality of categories for classifying a state of the work, by image recognition using various types of machine learning. For example, the plurality of categories is set to classify progress statuses of “absent” in which the worker W is away from the cell 8, as well as “working” in which the worker W is performing the work and “waiting” in which the worker W is waiting for the product 9 to be worked.

The controller 50 may be a hardware circuit such as a dedicated electronic circuit designed to realize a predetermined function or a reconfigurable electronic circuit. The controller 50 may be constituted by various semiconductor integrated circuits such as a CPU, an MPU, a GPU, a GPGPU, a TPU, a microcomputer, a DSP, an FPGA, and an ASIC.

The storage 52 is a storage medium that stores programs and data necessary for realizing the functions of the site monitoring PC 5. For example, the storage 52 is constituted by an HDD, an SSD, or the like, and stores the above-described program, image data acquired from the camera 2, map data D0 indicating the disposition of the cell 8 and the camera 2 at the site 6, and the like. For example, the map data D0 manages each cell 8 and the camera 2 that captures an image of the process performed in each cell 8 in association with each other.

The storage 52 includes an area that is constituted by a RAM such as a DRAM or an SRAM and temporarily stores (i.e., holds) data. The storage 52 may function as a work area of the controller 50, and it may include a storage area in an internal memory of the controller 50.

The user I/F 53 is a general term for operation members that receive an operation by the user 3. For example, the user I/F 53 is constituted by any one of a keyboard, a mouse, a trackpad, a touchpad, a button, a switch, and the like, or a combination thereof. The user I/F 53 acquires various types of information input in response to receiving the operation by the user 3.

The device I/F 54 is a circuit to connect an external device, such as the camera 2 and the sensors 85, to the site monitoring PC 5. The device I/F 54 performs data communication according to a predetermined communication standard. For example, the predetermined communication standard includes USB, HDMI (registered trademark), IEEE 802.11, Wi-Fi (registered trademark), and Bluetooth (registered trademark). The device I/F 54 is an example of an input interface in the site monitoring PC 5 that acquires or receives various types of information from an external device. For example, the site monitoring PC 5 receives image data indicating an image captured by the camera 2 and sensor data output from the sensors 85 via the device I/F 54. The device I/F 54 is an example of an image acquisition circuit in the site monitoring PC 5 of the present embodiment.

The output I/F 55 is a circuit to output information. For example, the output I/F 55 outputs various types of information to an external device such as the analysis PC 4 in accordance with a predetermined communication standard. For example, the predetermined communication standard includes USB, HDMI, IEEE 802.11, Wi-Fi, and Bluetooth.

The configuration of the site monitoring PC 5 described above is an example, and the configuration of the site monitoring PC 5 is not limited to this configuration. The site monitoring PC 5 may be configured by various computers including a server, and may perform data communication with the camera 2 and the sensors 85 at the site 6 via a communication network with the device I/F 54, for example. In addition to or instead of the output I/F 55, for example, the site monitoring PC 5 may include a display constituted by a liquid crystal display, an organic EL display, or the like as a built-in display device. The monitoring method of the present embodiment may be performed in distributed computing.

In addition to or instead of the configuration described above, the site monitoring PC 5 may have a configuration that communicates with an external device via a communication network. For example, the user I/F 53 may be configured to receive an operation input by an external device connected via a communication network. The output I/F 55 may transmit various types of information by being connected to an external device via a communication network.

The input interface in the site monitoring PC 5 may be realized by cooperation with various types of software in the controller 50 and the like. The input interface in the site monitoring PC 5 may acquire various pieces of information by reading various pieces of information stored in various storage media (e.g., the storage 52) to the work area of the controller 50.

### 1-3. Configuration of Analysis PC

FIG. 3 is a block diagram illustrating a configuration of the analysis PC 4. The analysis PC 4 of FIG. 3 includes a controller 40, a storage 42, a user I/F 43, a communication I/F 44, and a display 45.

The controller 40 includes, for example, a CPU or an MPU that realizes a predetermined function in cooperation with software, and controls an entire operation of the analysis PC 4. The controller 40 reads data and programs stored in the storage 42, performs various types of arithmetic processing, and realizes various functions.

For example, the controller 40 executes a program including a command group for realizing the function of the analysis PC 4. The above-described program may be provided from a communication network such as the Internet, or may be stored in a portable recording medium. The controller 40 may include an internal memory as a temporary storage area that holds various types of data and programs.

The controller 40 may be a hardware circuit such as a dedicated electronic circuit designed to realize a predetermined function or a reconfigurable electronic circuit. The controller 40 may be constituted by various semiconductor integrated circuits such as a CPU, an MPU, a GPU, a GPGPU, a TPU, a microcomputer, a DSP, an FPGA, and an ASIC.

The storage 42 is a storage medium that stores programs and data necessary for realizing the functions of the analysis PC 4. The storage 42 includes an area that is constituted by a RAM such as a DRAM or an SRAM and temporarily stores (i.e., holds) data. The storage 42 may function as a work area of the controller 40, and it may include a storage area in an internal memory of the controller 40.

The user I/F 43 is a general term for operation members that receive an operation by the user 3. For example, the user I/F 43 is constituted by any one of a keyboard, a mouse, a trackpad, a touchpad, a button, a switch, and the like, or a combination thereof. The user I/F 43 acquires various types of information input in response to receiving the operation by the user 3.

The communication I/F 44 is a circuit to connect the analysis PC 4 to a communication network via a wireless or wired communication line according to a predetermined communication standard. For example, the predetermined communication standard includes USB, HDMI, IEEE 802.11, Wi-Fi, and Bluetooth. For example, the communication I/F 44 is connected to the site monitoring PC 5 via a communication network and receives the information output from the output I/F 55 of the site monitoring PC 5. The communication I/F 44 is an example of an input interface for acquiring or receiving various types of information from an external device in the analysis PC 4.

The display 45 is a display device constituted by a liquid crystal display, an organic EL display, or the like. For example, the display 45 displays information received from the site monitoring PC 5 by the communication I/F 44. The display 45 may display various icons for operating the user I/F 43, information input from the user I/F 43, and the like.

The configuration of the analysis PC 4 described above is an example, and the configuration of the analysis PC 4 is not limited to this configuration. For example, the analysis PC 4 may be constituted by various computers such as a tablet terminal or a smartphone including a display. In addition to or instead of the configuration described above, the analysis PC 4 may have a configuration to be connected to an external information processing apparatus without using a communication network.

The input interface in the analysis PC 4 may be realized by cooperation with various types of software in the controller 40 and the like. The input interface in the analysis PC 4 may acquire various types of information by reading various types of information stored in various storage media (e.g., the storage 42) to the work area of the controller 40.

### 1-4. Disposition of Camera and Sensor

The disposition of the camera 2 and the sensors 85 connected to the site monitoring PC 5 as described above in the site monitoring system 1 will be described with reference to FIGS. 1, 4, and 5.

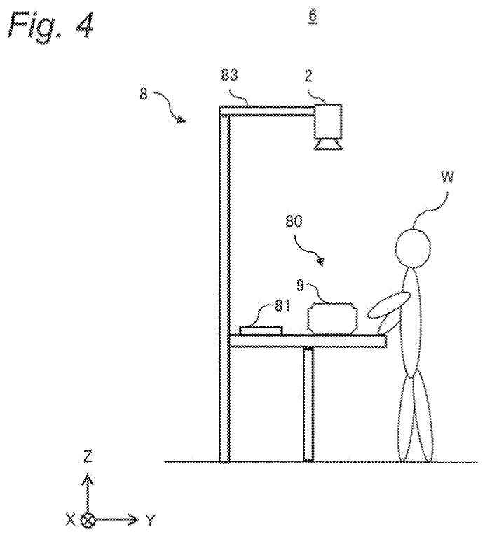

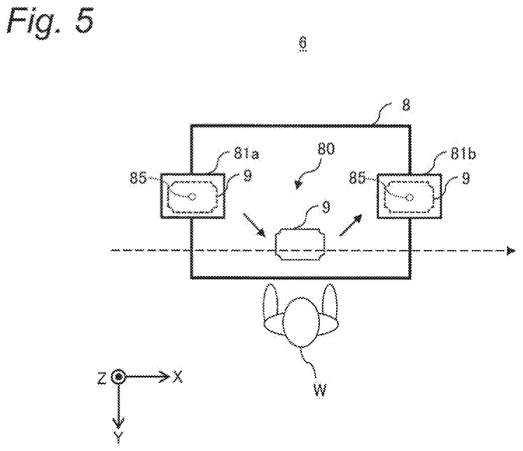

FIG. 4 is a diagram for describing a disposition of the camera 2 in the site monitoring system 1. FIG. 5 is a diagram for describing a disposition of the sensors 85 in the site monitoring system 1. Hereinafter, a vertical direction at the site 6 exemplified in FIG. 1 is referred to as a Z direction. The two directions perpendicular to each other on a horizontal plane orthogonal to the Z direction are referred to as an X direction and a Y direction, respectively. The +Z direction may be referred to as an upward direction, and the −Z direction may be referred to as a downward direction.

FIG. 4 illustrates an elevation view of the cell 8 at the site 6 as viewed from the X direction. For example, each cell 8 is provided with a cell base 83 on which the camera 2 is installed, a work table 80 for the worker W to perform work on the product 9, and a buffer 81 for temporarily placing an in-progress product before or after the work at the work table 80 is performed on the product 9. In the present system 1, each camera 2 is disposed so as to capture an image of a state in which the worker W performs work on the product 9 at the work table 80 of the corresponding cell 8 viewed from above, that is, in the downward direction. The camera 2 may be disposed to capture an image including the buffer 81.

FIG. 5 illustrates a plan view of the cell 8 viewed from above at the site 6, viewing downward from the camera 2 disposed as illustrated in FIG. 4, for example. As illustrated in FIG. 5, two buffers 81a and 81b are provided in each cell 8 of the site 6 illustrated in FIG. 1. The buffers 81a and 81b of each cell 8 are provided as places for placing the in-progress product, with reference to the cell 8, before and after performing work on the product 9 at the work table 80.

In the site 6 of the present example, work of the process in each cell 8 is performed conveying the product 9 in the +X direction for each product 9. In each cell 8, the worker W performs the work on the product 9 on the work table 80, picking up the product 9 from the buffer 81a, and places the product 9 after performing the work of the process onto the buffer 81b. In this way, work of each process is advanced. For example, the buffer 81a of each cell 8, as a particular cell 8, is shared with a preceding cell 8 where a previous process of the process in the particular cell 8 is performed in the work, and the buffer 81b is shared with a subsequent cell 8 where a next process of the process in the particular cell 8 is performed.

In the present system 1, each sensor 85 is installed on each buffer 81 (i.e., the buffers 81a and 81b) of the cell 8. For example, each sensor 85 is a proximity sensor that detects in a non-contact manner that an object such as the product 9 approaches the sensor 85, and it is constituted by a distance measuring sensor, a magnetic field sensor, or the like. In the present system 1, each sensor 85 repeats detection at a predetermined cycle and outputs sensor data indicating the detection result. For example, the sensor data indicates presence or absence of an object detected in proximity to each sensor 85 in each detection cycle.

### 2. Operation

The operations of the site monitoring system 1 and the site monitoring PC 5 configured as described above will be described below.

In the present system 1, for example, as illustrated in FIG. 1, the site monitoring PC 5 acquires the image data obtained by capturing images of each cell 8 in the site 6 with the corresponding camera 2 and the sensor data obtained by detecting the presence or absence of the product 9 on the buffer 81 with the sensors 85 at the cell 8. Based on the acquired image data and sensor data, the site monitoring PC 5 outputs information on the progress status of the process performed by the worker W in each cell 8, executing processing including image recognition processing to recognize the progress status of the processes performed in units of cells 8. The site monitoring system 1 visualizes the information output from the site monitoring PC 5 with the analysis PC 4 to present the information to the user 3.

For example, the site monitoring system 1 specifies a process as the bottleneck that causes delay in the work at the site 6, based on the progress statuses of the respective processes each recognized in the image of each cell 8 using the site monitoring PC 5, and displays a warning or the like in the analysis PC 4 for the specified process. For example, the analysis PC 4 displays, in accordance with a user operation responding to the warning display or the like, the image or other information of the cell 8 corresponding to the process specified as the bottleneck, the image being captured by the camera 2 at the time when the specified process is performed.

### 2-1. Problem of Bottleneck Determination and Processing Load

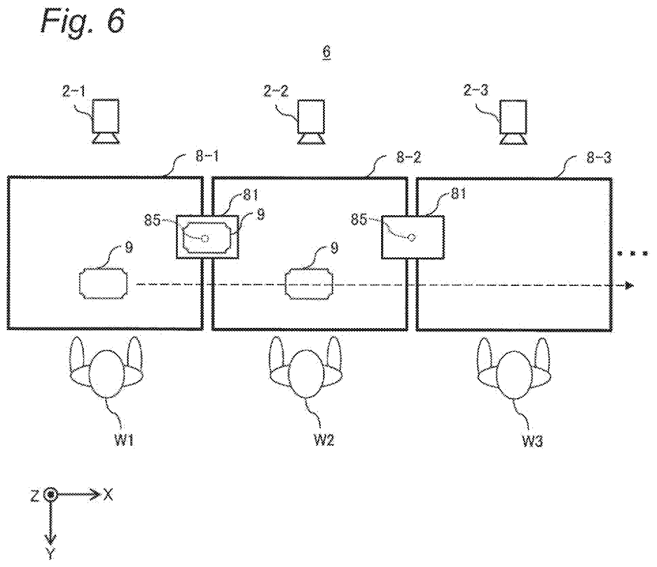

A problem that occurs when specifying the cell 8 of the bottleneck using the image recognition processing in the site monitoring system 1 will be described with reference to FIG. 6.

FIG. 6 is a diagram for describing the bottleneck determined in the site monitoring system 1. FIG. 6 illustrates the cameras 2-1 to 2-3 at the site 6 exemplified in FIG. 1 and the cells 8-1 to 8-3 captured from above by the cameras 2-1 to 2-3, respectively. In the example of FIG. 6, the product 9 subjected to the process in each cell 8 is placed on the buffer 81 between adjacent cells 8 so that the workers W1 to W3 sequentially perform the processes of the work in the cells 8-1 to 8-3 for each product 9.

For example, in a scene illustrated in FIG. 6, the workers W1 and W2 are working in the cells 8-1 and 8-2, respectively. In this scene, the product 9 is already placed on the buffer 81 between the cells 8-1 and 8-2, and the product 9 to be worked next in the cell 8-1 cannot be placed on the buffer 81. Further, for example, in a situation where the work of the worker W2 in the cell 8-2 is delayed, no product 9 is placed on the buffer 81 between the cells 8-2 and 8-3, and the worker W3 is in the waiting status at the cell 8-3. In such a situation, the cell 8-2 is considered to be the bottleneck that causes delay of the work.

The site monitoring PC 5 of the present system 1 performs image recognition processing on the images from the cameras 2-1 to 2-3, and recognizes the progress status of the progress in each of the cells 8-1 to 8-3. The site monitoring PC 5 specifies the bottleneck process in the cell 8-2 as described above according to a combination of the recognized progress statuses. The site monitoring PC 5 of the present embodiment can accurately recognize the progress status of the process in each cell 8 by using relatively advanced image recognition processing using machine learning or the like. However, when such image recognition processing frequently is performed, processing load may increase in the present system 1.

For example, in the site monitoring PC 5, when the image recognition processing is executed on the images of all the cells 8 in the site 6, it is concerned that a computational cost of the image recognition processing becomes excessive. Further, when relatively a large number of cells 8 and cameras 2 are used at the site 6, such processing load may become enormous. For example, to deal with the increased processing load, a possible option such as introducing a high-performance PC as the site monitoring PC 5 or implementation by distributed processing with a plurality of PCs also causes an increase in installation cost of the present system 1.

Thus, the site monitoring PC 5 of the present system 1 limits the image of the cell 8 to be the input to the image recognition processing from the images of the plurality of cells 8 captured by each camera 2 to omit the image recognition processing for the image of the cell 8 considered to be irrelevant to the bottleneck, based on the sensor data. For example, in the sensor data for the scene of FIG. 6, the product 9 tends to be detected on the buffer 81 on a side of the cell 8-1 but not detected on the buffer 81 on another side of the cell 8-3, and thus, it is considered that the product 9 dwells in the process in the cell 8-2. The site monitoring PC 5 of the present embodiment detects such a process where the product 9 dwells based on the sensor data, thereby specifying an image of the cell 8 considered to be related to the bottleneck.

The step of the cell 8-2 where such dwelling of the product 9 is detected is considered to be the bottleneck with a relatively high possibility. In this case, the site monitoring PC 5 of the present embodiment selects, as inputs for the image recognition processing, as well as the image of the cell 8-2 corresponding to the process where the dwelling is detected, the images of the cells 8-1 and 8-3 where processes performed before and after the process involving the dwelling in the cell 8-2, from among the images of the cells 8. Then, the site monitoring PC 5 executes the image recognition processing on the selected three images, but does not execute the image recognition processing on unselected images from among the images of the cells 8.

In this manner, the site monitoring PC 5 of the present embodiment selectively executes the image recognition processing from among the images of the plurality of cells 8 according to the detection of the dwelling of the product 9. According to the site monitoring PC 5 as the present embodiment, it is possible to accurately recognize the progress status of the process in the cell 8 with the processing load of the image recognition processing being suppressed, and perform determination of the bottleneck to specify the bottleneck process by determining whether or not each process is the bottleneck. This allows the site monitoring PC 5 of the present system 1 to reduce processing load for monitoring, with cameras 2, the work including the plurality of processes performed on the product 9, such as the processing load for the image recognition processing based on the images of the processes of the respective cells 8, and to efficiently monitor the work.

### 2-2. Operation of Site Monitoring PC

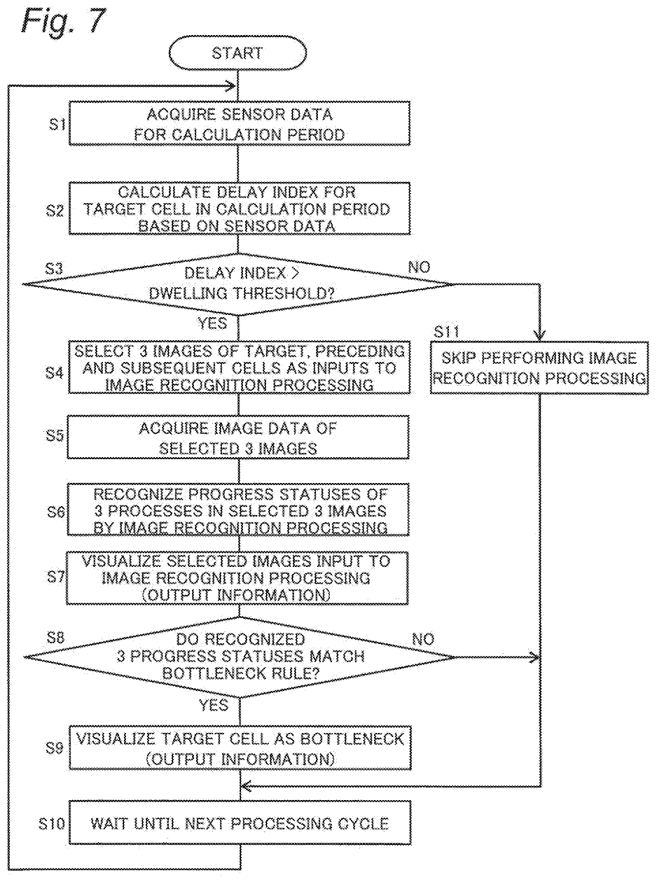

An operation of the site monitoring PC 5 in the site monitoring system 1 will be described with reference to FIGS. 7 to 11.

FIG. 7 is a flowchart illustrating an operation of the site monitoring PC 5 according to the first embodiment. For example, processing of the present flowchart is executed, as processing per cell 8, at a predetermined processing cycle with the work being performed at the site 6 for each target cell that is the cell 8 as a target of the processing. For example, the processing cycle is set to be equal to or longer than the cycle at which the sensor data is output from the sensors 85. Each processing of the present flowchart is executed by the controller 50 of the site monitoring PC 5.

The site monitoring PC 5 according to the present embodiment detects the process where the product 9 dwells for each cell 8 based on a period during which the product 9 is detected by the sensors 85 on the buffer 81 used in the process of each cell 8 (S1 to S3). For example, in the scene of FIG. 6, the dwelling of the product 9 is detected in the process of the cell 8-2 based on the period during which the product 9 is detected on the buffer 81 between the cells 8-1 and 8-2 and the period during which the product 9 is detected on the buffer 81 between the cells 8-2 and 8-3.

First, the controller 50 acquires the sensor data in accordance with the detection result of the product 9 by the sensors 85 in a predetermined calculation period from each sensor 85 via the device I/F 54, for example (S1). For example, the calculation period is set to be twice as long as the processing cycle of the present flowchart. The controller 50 may acquire the sensor data only from the sensor 85 corresponding to the target cell among the sensors 85.

Based on the acquired sensor data, the controller 50 calculates a delay index according to the dwelling of the product 9 in the target cell in the calculation period based on the period during which the product 9 is detected (S2). The delay index indicates a degree of the dwelling of the product 9 on a part upstream from the end of each process in the process of each cell 8, and is set as an index that increases as the product 9 dwells. Details of such calculation processing of the delay index will be described later.

The controller 50 determines whether the delay index calculated for the target cell is larger than a dwelling threshold set as magnitude of the delay index that may cause delay in the work (S3). The controller 50 detects the process in which the product 9 dwells by comparing the delay index with the dwelling threshold. The dwelling threshold is stored in advance in the storage 52, for example.

When the delay index is larger than the dwelling threshold (YES in S3), the controller 50 selects, each as the input for the image recognition processing, three images of the image of the target cell and the images of the preceding and subsequent cells 8 corresponding to the processes performed before and after the target cell, from among the images of cells 8 captured by cameras 2(S4). For example, to manage the selected images, the controller 50 may hold, in the storage 52, a flag or the like indicating whether the image for each cell 8 is selected.

The controller 50 acquires image data of the three images selected as the input for the image recognition processing, with the device I/F 54 from the camera 2 captured each image, for example (S5). For example, the controller 50 may specify the camera 2 associated with the cell 8 corresponding to each of the three images by referring to the map data D0 in the storage 52.

The controller 50 performs image recognition processing on the selected three images based on the acquired image data, and recognizes the progress statuses of three processes shown in the respective images (S6). For example, the controller 50 inputs the image data to the image recognizer 51 and causes the image recognizer 51 to output any category of “working”, “waiting”, and “absent” as the progress status of the process shown in the input image indicated by the image data.

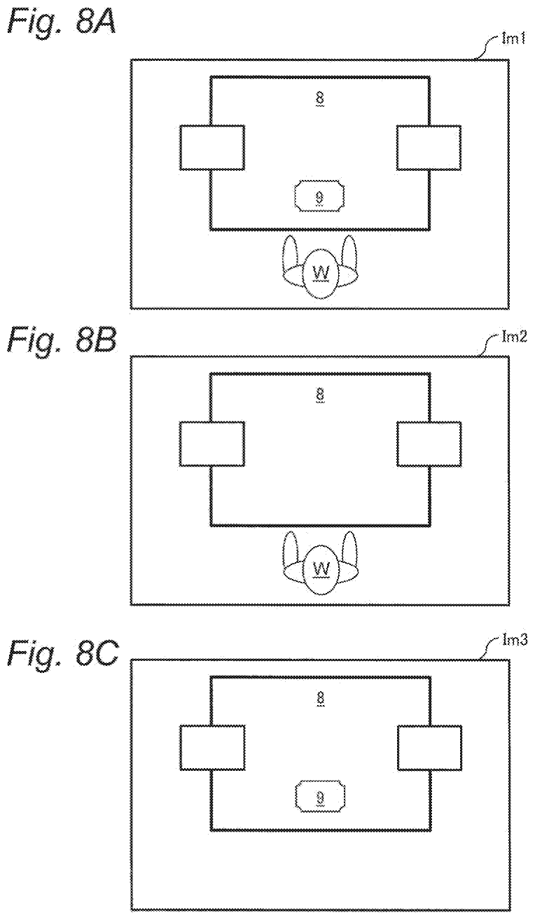

FIGS. 8A to 8C are diagrams for describing the image recognition processing (S6) in the site monitoring PC 5. FIGS. 8A to 8C illustrate images Im1 to Im3 in which one cell 8 is captured from above by the corresponding camera 2 at the site 6 as illustrated in FIG. 1. For example, when the images Im1, Im2, and Im3 are input, the image recognizer 51 outputs a category of “working”, “waiting”, or “absent” as a result of recognizing the progress status of the process performed by the worker W in the cell 8.

The controller 50 outputs, for example, information to visualize the image selected in step S4 to the user 3 in association with the image captured by each camera 2 to the analysis PC 4 with the output I/F 55 (S7). The information output in step S7 includes information identifying the image selected from the images captured by the cameras 2. Details of such visualization will be described later.

The controller 50 determines whether the target cell is the bottleneck based on the progress statuses of the three processes recognized by the image recognition processing for the selected images (S8). In the present embodiment, information defining a determination rule of the bottleneck process by combining the progress statuses for the respective processes is stored in advance in the storage 52 of the site monitoring PC 5, the bottleneck process being a process performed in the cell 8 determined as the bottleneck. The controller 50 determines the bottleneck referring to such bottleneck determination information.

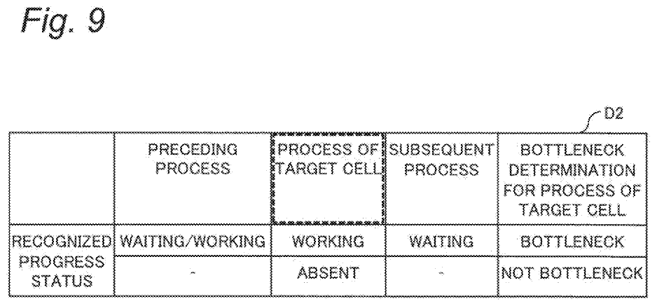

FIG. 9 is a diagram for describing the bottleneck determination information D2 in the site monitoring PC 5. The bottleneck determination information D2 manages the progress statuses of the three processes in association with the determination result as to whether the process of the target cell is determined as the bottleneck. Corresponding to the three images selected as the inputs for the image recognition processing, the three processes are, as well as the process of the target cell, processes of a preceding process and a subsequent process respectively performed before and after the process of the target cell, such as the previous process and the next process of the process of the target cell.

In the example of FIG. 9, when it is recognized that the progress status of the preceding process is “waiting” or “working”, the progress status of the target cell is “working”, and the progress status of the subsequent process is “waiting”, it is determined that the target cell as the bottleneck. On the other hand, when the progress status of the target cell is “absent”, the process of the target cell is not determined as the bottleneck regardless of the progress statuses of the preceding process and the subsequent process.

For example, in the scene illustrated in FIG. 6 described above, when the cell 8-2 is the target cell, the cell 8-2 can be determined as the bottleneck by using the bottleneck determination information D2 based on the progress status recognized from the images of the cells 8-1 to 8-3 as the inputs for the image recognition processing.

When determining that the target cell is the bottleneck (YES in S8), the controller 50 outputs information to visualize the target cell as the bottleneck to the analysis PC 4 with the output I/F 55 (S9). Details of such visualization will be described later together with the visualization in step S7.

After waiting until the next processing cycle (S10), the controller 50 repeats the processing of step S1 and subsequent steps. When determining that the target cell is not the bottleneck (NO in S8), the controller 50 proceeds to step S10 without visualizing the bottleneck (S9).

For example, even when the dwelling of the product 9 is detected in the process of the target cell (YES in S3), the process of the target cell may just shows a possibility of the bottleneck in a case where the progress status of the subsequent process is recognized as “working”. In such a case, according to the bottleneck determination information D2 of FIG. 9, the process of the target cell is not determined as the bottleneck (NO in S8). Even when the dwelling is detected (YES in S3), in a case where the progress status of the process of the target cell is recognized as “absent”, it is conceivable that the delay index becomes higher than the dwelling threshold because of a factor such as the worker W taking a break or a factor such as an irregular process in which only the buffer 81 of the target cell is used and no work is performed. Also in such a case, the target cell is not determined as the bottleneck according to the bottleneck determination information D2 (NO in S8).

On the other hand, when the delay index of the target cell is equal to or less than the dwelling threshold (NO in S3), the controller 50 skips executing the image recognition processing in step S6 without performing the processing in steps S4 to S9 described above (S11). Then, the controller 50 waits until the next processing cycle (S10) and repeats the processing of step S1 and subsequent steps. In this manner, the image recognition processing is not executed for the image of the cell 8 that is not selected as the input for the image recognition processing among the images of the plurality of cells 8 in the site 6 by using the delay index calculated based on the sensor data. This can reduce the processing load as compared with a case where the image recognition processing is executed for all the cells 8, for example.

According to the operation of the site monitoring PC 5, when the delay index of the target cell calculated from the sensor data is larger than the dwelling threshold (YES in S3), the images of the cells 8 corresponding to the preceding process and the subsequent process are selected as the inputs for the image recognition processing in addition to the image of the process of the target cell (S4). Then, the image recognition processing is executed on the selected images (S6), and the bottleneck is determined based on the progress statuses of the processes recognized in the respective images (S8). On the other hand, when the delay index is equal to or less than the dwelling threshold (NO in S3), such execution of the image recognition processing is skipped (S11).

In this manner, the image recognition processing can be selectively executed for the image of the process in which the dwelling of the product 9 is detected and the possibility of the bottleneck is relatively high and the images of the preceding and subsequent processes from the processes of respective cells 8 of the site 6, and the bottleneck can be accurately determined with the processing load being suppressed. For example, it is conceivable that the dwelling of the product 9 is erroneously detected because of a factor that the sensors 85 detect an article other than the product 9. In this case as well, it is possible to improve the bottleneck determination accuracy by combining the progress statuses of the three processes recognized by the image recognition processing.

When the processing described above is executed in synchronization for each cell 8, a result of selecting the images in each step S4 may be shared between two pieces of processing in which each of cells 8 of two consecutive processes is set as the target cell. For example, when the image of the same cell 8 is selected as the input for the image recognition processing between the two pieces of processing, the image recognition processing may be executed in common for the selected same cell 8, and the recognition result may be shared.

When the cell 8 for the first process in the work performed at the site 6 is set as the target cell, in steps S4 to S7, similar processing to the above described processing can be performed using the images of the process of the target cell and the subsequent process as the inputs for the image recognition processing, for example. When the cell 8 for the last process in the work is set as the target cell, in steps S4 to S7, similar processing to the above described processing can also be performed using the images of the process of the target cell and the previous process as the inputs for the image recognition processing.

### 2-2-1. Calculation of Delay Index

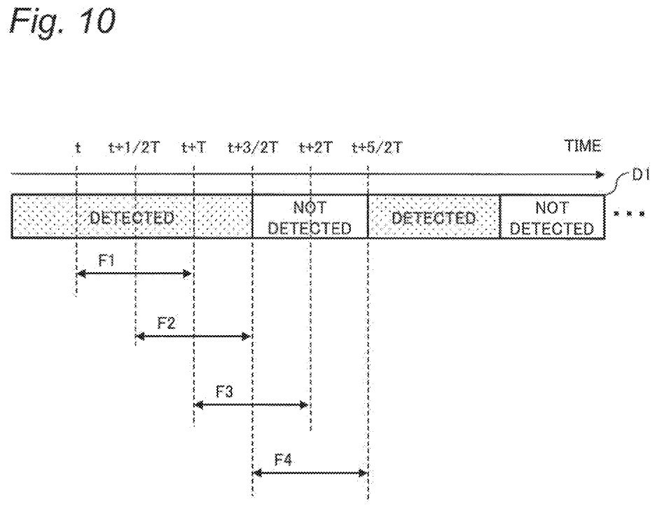

The calculation processing to calculate the delay index of the target cell in step S2 of FIG. 7 will be described with reference to FIG. 10.

FIG. 10 is a diagram for describing the calculation processing of the delay index in the site monitoring PC 5. Sensor data D1 of the present example indicates the presence or absence of the product 9 on the buffer 81 by whether or not the product 9 is detected with the sensors 85. FIG. 10 illustrates four calculation periods F1, F2, F3, and F4 for each processing cycle of the processing illustrated in FIG. 7. In the example of FIG. 10, the processing cycle is 2/T, and each of the calculation periods F1 to F4 is set to be twice as long as the processing cycle.

The controller 50 calculates by the following calculation formula 1, as the detection rate of the product 9 on the buffer 81, a proportion of a period during which the product 9 is detected in the sensor data D1 among the calculation period. The detection rates in the example of FIG. 9 are “1” in the calculation period F1, “1” in the calculation period F2, “0.5” in the calculation period F3, and “0” in the calculation period F4, respectively.

$$Detection rate of product 9 on buffer 81 = period during which product 9 is detected on buffer 81 during calculation period / calculation period \qquad ( Calculation Formula 1 )$$

In step S2, the controller 50 calculates the detection rate for the buffer 81 related to the target cell with the calculation formula 1. For example, in each cell 8 as illustrated in FIG. 5, the controller 50 calculates the detection rate for each of the buffers 81a and 81b respectively used before and after performing work on the product 9 at the work table 80.

The controller 50 calculates with the following calculation formula 2, as the delay index of the cell 8, a value obtained by subtracting the detection rate for the buffer 81b disposed on a downstream part of the process in the cell 8, from the detection rate for the buffer 81a disposed on an upstream part of the process.

$$Delay index of cell 8 = detection rate for buffer 81 a - detection rate for buffer 81 b \qquad ( Calculation Formula 2 )$$

According to the calculation processing, the delay index is calculated as an index having a larger value as the detection rate of the product 9 is higher for the buffer 81a on the upstream part of the process in the cell 8 and as the detection rate is lower for the buffer 81b on the downstream part of the process. Therefore, the delay index can be calculated so as to indicate the degree of the dwelling of the product 9 on the upstream part of the process in each cell 8.

### 2-2-2. Visualization

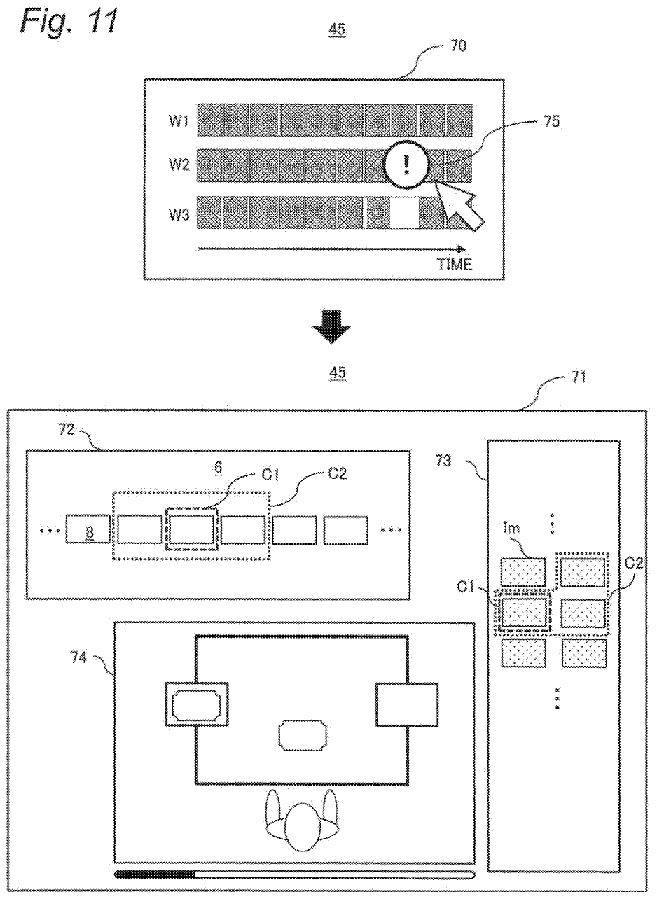

The visualization in steps S7 and S9 in FIG. 7 will be described with reference to FIG. 11.

FIG. 11 is a diagram for describing an analysis screen in the site monitoring system 1 of the present embodiment. For example, the analysis PC 4 of the present system 1 displays, on the display 45, an analysis screen for the user 3 to analyze work efficiency and the like at the site 6 based on the information output from the site monitoring PC 5 in steps S7 and S9.

The controller 40 of the analysis PC 4 first causes the display 45 to display, as the analysis screen, a work timeline 70 indicating whether the work is being performed by the worker W in each cell 8 for respective times. For example, the work timeline 70 illustrated in FIG. 11 is generated based on the progress status recognized for each of the processes of the cells 8-1 to 8-3 when the dwelling is detected in the process of the cell 8-2 where the worker W2 works (YES in S3). For example, in step S9, in addition to the generated work timeline 70, the site monitoring PC 5 outputs information indicating the cell 8 (or the corresponding worker W) of the process determined as the bottleneck in step S8 and the time, to the analysis PC 4 with the output I/F 55.

The analysis PC 4 displays a warning icon 75 that warns occurrence of the bottleneck, for example, in a superimposed manner on the work timeline 70. In the example of FIG. 11, the warning icon 75 is displayed for the worker W2 in the cell 8-2. The analysis PC 4 receives an operation by the user 3 designating the warning icon 75 such as clicking on the user I/F 43, and displays a moving image including an image captured at the time when the bottleneck occurred, for the cell 8 of the bottleneck process or the like, the image captured by the corresponding camera 2. The analysis PC 4 may directly acquire the image data indicating the moving image from the camera 2 via the communication I/F 44 or may acquire the image data via the site monitoring PC 5.

The analysis PC 4 displays a viewer 71 for the user 3 to view the moving image and the like of the bottleneck process in response to the user operation of designating the warning icon 75. The viewer 71 illustrated in FIG. 11 displays a layout 72 illustrating the disposition of the cells 8 viewed from above at the site 6, a camera list 73 displaying thumbnails of the images captured by the respective cameras 2, and a player 74 to reproduce the moving image.

For example, as illustrated in FIG. 11, the display 45 of the analysis PC 4 displays a bottleneck display C1 indicating the cell 8 of the bottleneck and a selective display C2 indicating the cell 8 in the image selected as the input for the image recognition processing, the bottleneck display C1 and the selective display C2 being in different display styles and overlayed on the layout 72. In the camera list 73 as well, the display 45 highlights the image of the bottleneck process among the images taken by the cameras 2 with the bottleneck display C1 and the image selected as the input for the image recognition processing with the selective display C2. In the example of FIG. 11, in response to the three images being selected in step S4 of FIG. 7, three cells 8 are highlighted in the layout 72 with the selective display C2, and the three images are highlighted in the camera list 73.

For example, the analysis PC 4 causes the player 74 to display the moving image of the cell 8 of the bottleneck in response to the user operation designating the bottleneck display C1 with the user I/F 43. Therefore, for example, even when a large number of cells 8 are installed at the site 6, the user 3 can easily browse the moving image of the cell 8 of the bottleneck and easily analyze the factor and the like of the bottleneck.

Further, for example, the analysis PC 4 of the present embodiment causes the player 74 to display the moving image corresponding to the designated image in response to the user operation designating any of the three images highlighted with the selective display C2. The analysis PC 4 also displays the moving image of the cell 8 corresponding to the designation by the user operation designating any one of the three cells 8 highlighted with the selective display C2. According to the selective display C2, it is possible to call attention of the user 3 or the like to the images selected as the inputs for the image recognition processing and to the cells 8 in the selected images, which is selected as being related to the process in which the dwelling of the product 9 is detected. Therefore, it is possible to easily analyze the cell 8 of the process related to the dwelling of the product 9, which may be a sign of the bottleneck, by viewing the moving image or the like.

In the above-described example, the analysis PC 4 displays the bottleneck display C1 and the selective display C2 in both the layout 72 and the camera list 73, but the analysis PC 4 may display the bottleneck display C1 and the selective display C2 in either the layout diagram 72 or the camera list 73. The display for visualizing the images selected by detecting the dwelling may be performed in the viewer 71 or the like even when the target cell is not determined as the bottleneck in step S8 of FIG. 7.

An example of visualization in the analysis PC 4 is described above, but for example, in the site 6, a lamp or the like may be installed for each cell 8, and the cell 8 corresponding to the image selected by the detection of the cell 8 as the bottleneck and/or the dwelling may be visualized by turning on the lamp. In addition, for example, the worker W in the cell may be notified of the occurrence of the bottleneck or the dwelling of the product 9 using a speaker or the like.

### Modification of First Embodiment

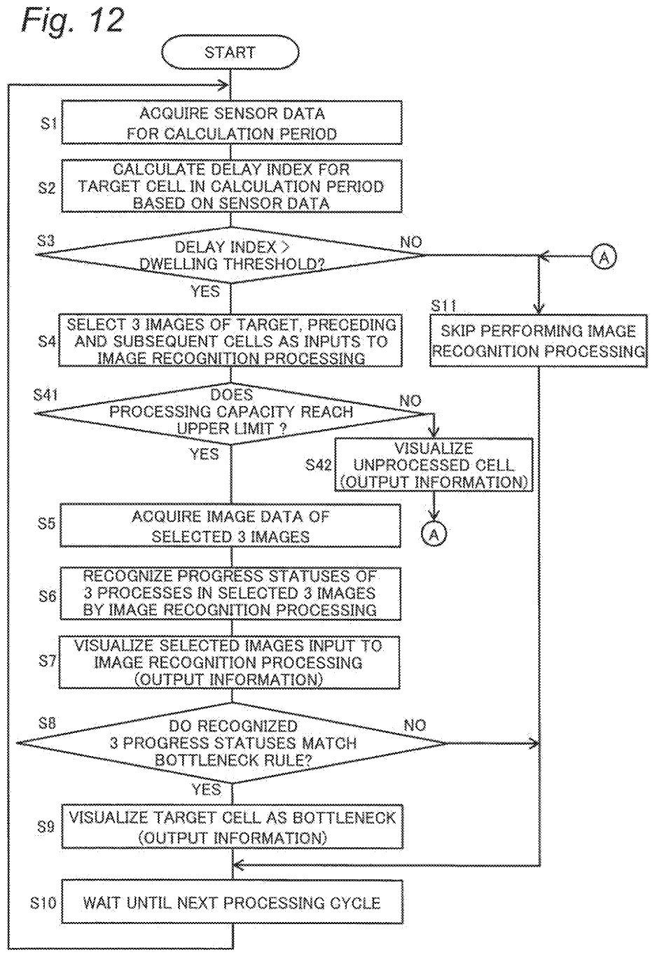

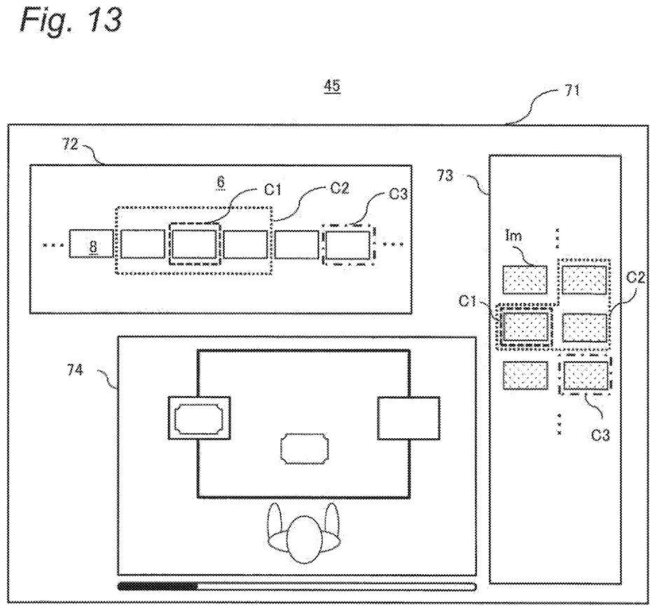

In the first embodiment described above, an example is described in which the site monitoring system 1 visualizes an image of the bottleneck process, an image selected as the input for the image recognition processing, and the like. The site monitoring system 1 may further perform visualization according to processing capacity required for the image recognition processing. Such a modification of the first embodiment will be described with reference to FIGS. 12 and 13.

FIG. 12 is a flowchart illustrating an operation of the site monitoring PC 5 in the present modification. The present flowchart includes, in addition to the processing (S1 to S11) similar to that of the first embodiment, processing related to visualization according to the processing capacity of the site monitoring PC 5 (S41, S42). For example, in the site monitoring PC 5 of the present modification, for the images of the cells 8, an upper limit value of the number of cells 8 corresponding to the number of images to which the image recognition processing can be applied at one time is set in advance as an upper limit of the processing capacity and stored in the storage 52.

For example, after selecting the input for the image recognition processing from the image of each cell 8 (S4), the controller 50 of the site monitoring PC 5 determines whether the processing capacity reaches the upper limit for the image recognition processing on the selected input image (S41). For example, when the image recognition processing is applied to the images of the three cells 8 selected in step S4, the controller 50 determines that the processing capacity reaches the upper limit when a sum of the number of cells 8 corresponding to the number of selected images is larger than the upper limit value in the processing of FIG. 12 executed for each cell 8. Whether the image is selected as the input for the image recognition processing for each cell 8 may be managed by a shared flag or the like between a plurality of pieces of processing with each cell 8 as the target cell. For example, the controller 50 may hold such a flag in the storage 52.

When the processing capacity does not reach the upper limit (NO in S41), the controller 50 acquires the image data of the images selected in step S4 (S5), and performs the image recognition processing (S6).

When the processing capacity reaches the upper limit (YES in S41), the controller 50 outputs, to the analysis PC 4, information to visualize the cell 8 in the image selected in step S4 as an unprocessed cell to which the image recognition processing has not been applied to the selected image of the cell. For example, the output information identifies the image of the unprocessed cell among the images captured by the cameras 2. In this case, the controller 50 skips the execution of the image recognition processing (S11), and proceeds to step S10.

FIG. 13 is a diagram for describing an analysis screen in the site monitoring system 1 of the present modification. In the present modification, in addition to the bottleneck display C1 and the selective display C2 similar to those of the first embodiment, the analysis PC 4 displays an unprocessed display C3 indicating the unprocessed cell on the analysis screen in a display style different from the bottleneck display C1 and the selective display C2. For example, as illustrated in FIG. 13, the display 45 of the analysis PC 4 highlights the unprocessed cell and the image from the corresponding camera 2 with the unprocessed display C3 in each of the layout 72 and the camera list 73.

In this manner, according to the site monitoring system 1 of the present modification, when the processing capacity reaches the upper limit when the image recognition processing is applied to the image selected in step S4 (YES in S41), the cell 8 in the image is visualized as the unprocessed cell (S42). In this case, the image recognition processing is not performed on the selected image (S11). Therefore, for example, even when the image recognition processing cannot be applied because of restriction of the processing capacity, it is possible to call attention of the user 3 or the like to the image of the unprocessed cell selected as the input for the image recognition processing, the image of the unprocessed cell being selected in relation to the process that can be the bottleneck in which the dwelling of the product 9 is detected.

### 3. Effects

As described above, in the present embodiment, the site monitoring system 1 monitors, with the camera 2 that is an example of at least one camera, the work (an example of a work process) including a plurality of processes performed on the product 9 (an example of an object). The site monitoring system 1 includes, in the site monitoring PC 5, the device I/F 54 as an example of the image acquisition circuit and the controller 50. The device I/F 54 acquires image data indicating each of a plurality of images (an example of a plurality of monitoring images) obtained by capturing the plurality of processes with the camera 2 (S5). The controller 50 executes image recognition processing to recognize a progress status as an example of a status of each process in the work based on the image data (S4 to S6). Based on the sensor data as an example of sensor information indicating a detection result of the product 9 in the work, the controller 50 selects an image as an input for the image recognition processing from among the plurality of images (S4). The controller 50 does not perform the image recognition processing on an unselected image among the plurality of images (S11), but performs the image recognition processing on the selected image (S6).

According to the site monitoring PC 5 described above, the image recognition processing can be selectively executed on the image selected based on the sensor data as the input for the image recognition processing from among the images of the plurality of processes captured by the camera 2, and the processing load can be reduced. Therefore, regarding the work including the plurality of processes performed on the product 9, the processing load for monitoring the work with the camera 2 can be reduced.

In the present embodiment, the controller 50 detects a process in which the product 9 dwelled among the plurality of processes based on the sensor data (S2, S3), and selects the monitoring image corresponding to the detected process in which the dwelling is detected from among the plurality of images as the input for the image recognition processing (S4). Therefore, for example, the image to be used as the input for the image recognition processing can be selected according to a relatively high possibility that the process involving the dwelling of the product 9 becomes the bottleneck.

In the present embodiment, the controller 50 acquires the detection result of the product 9 with the sensors 85 different from the camera 2, as sensor data, and detects the process involving the dwelling based on the sensor data (S1 to S3). For example, in the detection result of the product 9 acquired from the sensors 85, the process involving the dwelling can be detected according to the period during which the product 9 is detected.

In the present embodiment, each sensor 85 includes a proximity sensor that detects proximity of the product 9 to the sensor 85. For example, by the sensors 85, the presence or absence of the product 9 can be detected according to whether or not the proximity is detected.

In the present embodiment, the controller 50 executes the image recognition processing on the selected image corresponding to the detected process in which the dwelling is detected among the plurality of images (YES in S3, S6), and does not execute the image recognition processing on the unselected image corresponding to an undetected process in which the dwelling is not detected (NO in S3, S11). Therefore, for example, in accordance with a fact that the process in which the dwelling is detected is relatively likely to be the bottleneck, the image recognition processing can be selectively executed on the image of the process related to the bottleneck.

In the present embodiment, the controller 50 selects, each as the input for image recognition processing, the image corresponding to the detected process in which the dwelling is detected and the images corresponding to the preceding process and the subsequent process of the detected process in which the dwelling is detected from among the plurality of images (S4). For example, in the work at the site 6 illustrated in FIG. 1, when the dwelling of the product 9 is detected in the process of the cell 8-2 as in the scene of FIG. 6, three images are selected as the image in which the detected process of the cell 8-2 is captured by the camera 2-2 and the images in which the preceding and subsequent processes are captured by the cameras 2-1 and 2-3. Therefore, for example, each as the image of the process related to the bottleneck, the image recognition processing can be executed not only for the image of the detected process in which the dwelling is detected but also for the images of the processes performed before and after the detected process, and the progress status recognized in each image can be obtained.

In the present embodiment, the controller 50 specifies the bottleneck process as an example of a process that is a factor of delay of the work in the plurality of processes based on the progress status of each process recognized by the image recognition processing (S8). Therefore, for example, even when the dwelling of the product 9 is erroneously detected based on the sensor data because of an erroneous reaction to an article other than the product 9 by the sensors 85, the bottleneck process can be accurately specified based on the progress status recognized by the image recognition processing.

In the present embodiment, the controller 50 specifies the bottleneck process based on a combination of the progress status of the detected process in which the dwelling is detected and respective progress status of the preceding and subsequent processes of the detected process (S8, see FIG. 9). Therefore, it is possible to improve the bottleneck determination accuracy by combining the progress statuses recognized in the images of the processes considered to be related to the bottleneck.

In the present embodiment, the site monitoring PC 5 of the site monitoring system 1 further includes the output I/F 55 as an example of an output circuit that outputs information. The controller 50 causes the output I/F 55 to output information to identify the selected image from among the plurality of images (S7). Therefore, for example, based on the output information, the plurality of images obtained by capturing the plurality of processes can be displayed in the PC 4 or the like that receives the information, and visualization can be performed changing the display style of the images selected as the inputs for the image recognition processing. According to such visualization, for example, it is possible to call attention of the user 3 or the like to the images of the processes selected as being related to the bottleneck and/or the cells 8 in the selected images.

In the present embodiment, the controller 50 outputs information to identify the image in which the bottleneck process is captured among the plurality of images (S9). Therefore, for example, in the PC 4 or the like that receives the information, similarly to the visualization based on the information in step S7, it is possible to perform visualization such that displays the plurality of images obtained by capturing the plurality of processes, and changes the display style of the image obtained by capturing the bottleneck process. According to such visualization, for example, a warning or the like can be issued to the user 3 or the like for the image of the bottleneck process and/or the corresponding cell 8 in the image.

In the present embodiment, the at least one camera 2 includes the plurality of cameras 2-1 to 2-3 and the like, and the plurality of images are captured by the plurality of cameras 2-1 to 2-3. As described above, in the present embodiment, the image to be used as the input for image recognition processing is selected from among the plurality of images captured by the cameras 2 as the plurality of monitoring images.

In the present embodiment, the image recognition processing recognizes the behavior state as an example of an action of the worker W in the work as the progress status for each process (S6). As described above, for example, the progress status of the worker W for each process, such as “working”, “waiting”, and “absent”, can be recognized according to the behavior state of the worker W.

The present embodiment provides a monitoring method for monitoring, with the camera 2 that is an example of at least one camera, the work (an example of a work process) including a plurality of processes performed on the product 9 (an example of an object). The monitoring method includes the steps of: acquiring (S5), with the site monitoring PC 5 as an example of a computer, image data indicating each of a plurality of images (an example of a plurality of monitoring images) obtained by capturing the plurality of processes with the at least one camera 2; and executing (S4 to S6), with the controller 50 of the site monitoring PC 5, image recognition processing to recognize the progress status (an example of a status) of each process in the work based on the image data. In executing the image recognition processing, the controller 50: selects (S4) an image as an input for the image recognition processing from among the plurality of images based on the sensor data as an example of sensor information indicating a detection result of the product 9 in the work; and executes (S6) the image recognition processing on the selected image from among the plurality of images without executing (S11) the image recognition processing on an unselected image from among the plurality of images.

In the present embodiment, the storage 52 is provided as an example of a tangible non-transitory computer readable medium storing a program for causing the controller 50 (an example of a controller of a computer) of the site monitoring PC 5 to execute such a monitoring method. According to the monitoring method and the program of the present embodiment, the processing load of the image recognition processing can be reduced, and the processing load of monitoring the work with the camera 2 can be reduced.

### Other Embodiments

As described above, the first embodiment is described as an example of the technique disclosed in the present application. However, the technique in the present disclosure is not limited to the embodiment, but it can also be applied to embodiments in which changes, substitutions, additions, omissions, and the like are made as appropriate. It is also possible to combine the components described in the above embodiments to form a new embodiment. Thus, other embodiments will be exemplified below.

In the first embodiment described above, an example in which one cell 8, one camera 2, and one worker W correspond to each other is described. In the present embodiment, it is not limited to such a one-to-one correspondence, but for example, images of a plurality of cells 8 may be captured by one or more cameras 2 shared with the plurality of cells 8, or work by a plurality of workers W may be performed in one cell 8. Although three cells 8 are illustrated in FIG. 1, the number of cells 8 at the site 6 may be two, and the number of cameras 2 may be two or less. In addition, the relationship between the processes and the cells 8 is not limited to the above-described example, and for example, a plurality of consecutive processes may be performed in one cell 8.

In the first embodiment described above, an example in which the site monitoring system 1 includes a plurality of cameras 2 is described. In the present embodiment, the site monitoring system may include only one camera. The camera of the present embodiment may be constituted by, for example, an omnidirectional camera or the like, and the camera is disposed to capture respective cells 8 in a bird's-eye view at the site 6. Also in this case, for example, instead of the image from each camera 2 in the first embodiment, by selecting a region to be the input for the image recognition processing for each region where each cell 8 is captured in the image by one camera, processing similar to that in the first embodiment can be performed.

In the first embodiment described above, an example is described in which the work timeline 70 is displayed in the site monitoring system 1, the work time line 70 indicating whether the worker W in each cell 8 performs the work for each time, each cell 8 being related to the detected process in which the dwelling of the product 9 is detected. In the present embodiment, in addition to or instead of the work timeline 70 of the first embodiment, the site monitoring system may display the delay index for each time calculated for each cell 8 regardless of detection of the dwelling, for example.

In the first embodiment described above, the sensors 85 of the site monitoring system 1 are installed on the buffer 81 of the cell 8. In the site monitoring system of the present embodiment, each sensor 85 may be installed on the work table 80 of the cell 8. For example, similarly to the detection rate of the product 9 on each buffer 81, the site monitoring PC 5 of the present embodiment may calculate the detection rate at each work table 80 and use the detection rate as the delay index for each cell 8.

In the first embodiment, each sensor 85 of the site monitoring system 1 is constituted as the proximity sensor that detects the proximity of the product 9 in a non-contact manner. In the present embodiment, the sensor of the site monitoring system may be a contact type physical sensor that detects contact with the product 9. The sensor may be constituted by a camera, and the presence or absence of the product 9 in the cell 8 may be detected based on temporal changes of luminance in a moving image obtained by capturing the cell 8 in which the cell 8 is disposed in work. The camera may be different from the camera 2 that captures an image as the input for the image recognition processing.

In this manner, in the above-described embodiments, the sensor of the site monitoring system 1 includes at least one of a proximity sensor such as each sensor 85 and another camera different from the camera 2. The camera from which the sensor data is acquired is not limited to the above-described example, and it may be the same as the camera 2. That is, the controller 50 may acquire image data from the camera 2 as the sensor data and detect a process in which the product 9 dwells based on the sensor data.

In the first embodiment, an example in which the site monitoring system 1 includes the camera 2 and the sensors 85 is described. The site monitoring system of the present embodiment may not include the camera 2 and/or may not include the sensors 85. In this case as well, the site monitoring system can perform the similar operation to that in the first embodiment by receiving the image data from an external camera and/or receiving the sensor data from an external sensor. For example, as the site monitoring system, the monitoring system of the present disclosure may be realized by the site monitoring PC 5.

In the first embodiment described above, the site monitoring system 1 visualizes the image selected as the input for the image recognition processing with the selective display C2. For example, when the site monitoring system according to the present embodiment determines that the target cell is the bottleneck (YES in S8), the site monitoring system may specify the cell 8 adjacent to the bottleneck cell 8 at the site 6 based on the map data D0. In the present embodiment, the analysis PC 4 may visualize the adjacent cells 8 and the images thereof instead of the selective display C2. In this case, the processing in step S7 in FIG. 7 may not be executed. By such visualization as well, the cell 8 that is possibly related to the bottleneck can be presented to the user 3 or the like.

In the first embodiment described above, in the site monitoring system 1, the site monitoring PC 5 acquires the sensor data from the sensors 85 and acquires the image data from the camera 2. In the present embodiment, the sensor data and/or the image data may be held in a database outside the site monitoring PC 5, and the site monitoring PC 5 may acquire each piece of data from the database. In addition, the analysis PC 4 may acquire the image data from the database and reproduce the moving image.

In the first embodiment described above, an example is described in which the site monitoring system 1 operates in real time when the work is performed at the site 6. In the present embodiment, the operation of the site monitoring system may be applied to image data recorded on a recording medium for a period in which the work is performed and collected sensor data.

In the first embodiment, an example is described in which the image recognition processing is executed in the site monitoring PC 5 at the site 6. In the present embodiment, the image recognition processing may be executed in a server or the like outside the site monitoring PC 5. In this case, the site monitoring PC 5 may cause the server to acquire the image data in step S5 of FIG. 7, and may receive the result of the image recognition processing from the server in step S6.

In each of the above-described embodiments, an example in which the site monitoring system 1 is applied to the site 6 such as a factory is described. In the present embodiment, the site to which the site monitoring system 1 and the site monitoring PC 5 are applied is not limited to the site 6 described above, but it may be various sites such as a distribution warehouse and a shop floor. The work determined in the site monitoring system 1 is not limited to the above-described examples, but it may be various works according to various sites. For example, at a site of a distribution warehouse, the site monitoring system 1 may be applied to analysis of work including processes such as pickup and box packing with an article such as a package as a target object of the work instead of the product 9.

In each of the above-described embodiments, an example in which the site monitoring system 1 is applied to a person such as the worker W is described. In the present embodiment, the worker to be analyzed by the site monitoring system 1 is not limited to a person, but it may be a movable body capable of executing various works, or may be a production facility or the like provided for each work. For example, the movable body may be a robot, or may be various manned or unmanned vehicles.

The embodiments are described as examples of the technique in the present disclosure as described above. For this purpose, the accompanying drawings and the detailed description are provided.

Thus, the components described in the accompanying drawings and the detailed description may include not only components essential for solving the problem but also components that are not essential for solving the problem in order to illustrate the above-described technique. Thus, it should not be immediately recognized that these non-essential components are essential based on the fact that these non-essential components are described in the accompanying drawings and the detailed description.

### Aspects of Present Disclosure

Hereinafter, aspects of the present disclosure will be exemplified.

A first aspect according to the present disclosure is a monitoring system that monitors, with at least one camera, a work process including a plurality of processes performed on an object. The monitoring system includes: an image acquisition circuit that acquires image data indicating each of a plurality of monitoring images obtained by capturing the plurality of processes with the at least one camera; and a controller that executes image recognition processing to recognize a status of each process in the work process based on the image data. The controller selects a monitoring image as an input for the image recognition processing from among the plurality of monitoring images based on sensor information indicating a detection result of the object in the work process, and executes the image recognition processing on the selected monitoring image from among the plurality of monitoring images without executing the image recognition processing on an unselected monitoring image from among the plurality of monitoring images.

A second aspect is the monitoring system according to the first aspect, wherein the controller detects a process in which the object dwells among the plurality of processes based on the sensor information, and selects the monitoring image corresponding to the detected process in which the dwelling is detected from among the plurality of monitoring images as the input for the image recognition processing.

A third aspect is the monitoring system according to the second aspect, wherein the controller acquires the detection result of the object with a sensor different from the at least one camera as the sensor information, and detects the process in which the object dwells based on the sensor information.

A fourth aspect is the monitoring system according to the third aspect, wherein the sensor includes at least one of a proximity sensor or another camera different from the at least one camera.

A fifth aspect is the monitoring system according to the second aspect, wherein the controller acquires the image data from the at least one camera as the sensor information and detects the process in which the object dwells based on the sensor information.

A sixth aspect is the monitoring system according to any of the second to fifth aspects, wherein the controller executes the image recognition processing on the selected monitoring image corresponding to the detected process in which the dwelling is detected among the plurality of monitoring images, and the controller does not execute the image recognition processing on the unselected monitoring image corresponding to an undetected process in which the dwelling is not detected among the plurality of monitoring images.

A seventh aspect is the monitoring system according to any of the second to sixth aspects, wherein the controller selects, each as the input for the image recognition processing, the monitoring image corresponding to the detected process in which the dwelling is detected and monitoring images corresponding to preceding process and subsequent process of the detected process from among the plurality of monitoring images.

An eighth aspect is the monitoring system according to any of the first to seventh aspects, wherein the controller specifies a process that is a factor of delay of the work process in the plurality of processes based on the status of each process recognized by the image recognition processing.

A ninth aspect is the monitoring system according to the seventh aspect, wherein the controller specifies a process that is a factor of delay of the work process in the plurality of processes based on a combination of the status of the detected process in which the dwelling is detected and respective statuses of the preceding process and subsequent process of the detected process.

A tenth aspect is the monitoring system according to any of the first to ninth aspects, further including an output circuit that outputs information. The controller causes the output circuit to output information to identify the selected monitoring image from among the plurality of monitoring images.

An eleventh aspect is the monitoring system according to any of the first to tenth aspects, wherein the at least one camera includes a plurality of cameras, and the plurality of monitoring images is captured by the plurality of cameras.

A twelfth aspect is the monitoring system according to any of the first to eleventh aspects, wherein the image recognition processing recognizes an action of a worker in the work process as the status of each process.

A thirteenth aspect of the present disclosure is a monitoring method for monitoring, with at least one camera, a work process including a plurality of processes performed on an object. The monitoring method including: acquiring, with a computer, image data indicating each of a plurality of monitoring images obtained by capturing the plurality of processes with the at least one camera; and executing, with a controller of the computer, image recognition processing to recognize a status of each process in the work process based on the image data. In executing the image recognition processing, the controller: selects a monitoring image as an input for the image recognition processing from among the plurality of monitoring images based on sensor information indicating a detection result of the object in the work process; and executes the image recognition processing on the selected monitoring image from among the plurality of monitoring images without executing the image recognition processing on an unselected monitoring image from among the plurality of monitoring images.

A fourteenth aspect is a non-transitory computer readable medium storing a program for causing a controller of a computer to execute the monitoring method according to the thirteenth aspect.

The present disclosure is applicable to data analysis for analyzing efficiency of work performed in various environments such as a factory and a distribution site.

1. A monitoring system that monitors, with at least one camera, a work process including a plurality of processes performed on an object, the monitoring system comprising:
an image acquisition circuit that acquires image data indicating each of a plurality of monitoring images obtained by capturing the plurality of processes with the at least one camera; and
a controller that executes image recognition processing to recognize a status of each process in the work process based on the image data,
wherein the controller:
selects a monitoring image as an input for the image recognition processing from among the plurality of monitoring images based on sensor information indicating a detection result of the object in the work process, and
executes the image recognition processing on the selected monitoring image from among the plurality of monitoring images without executing the image recognition processing on an unselected monitoring image from among the plurality of monitoring images.

2. The monitoring system according to claim 1, wherein
the controller
detects a process in which the object dwells among the plurality of processes based on the sensor information, and
selects the monitoring image corresponding to the detected process in which the dwelling is detected from among the plurality of monitoring images as the input for the image recognition processing.

3. The monitoring system according to claim 2, wherein
the controller acquires the detection result of the object with a sensor different from the at least one camera as the sensor information, and detects the process in which the object dwells based on the sensor information.

4. The monitoring system according to claim 3, wherein
the sensor includes at least one of a proximity sensor or another camera different from the at least one camera.

5. The monitoring system according to claim 2, wherein
the controller acquires the image data from the at least one camera as the sensor information and detects the process in which the object dwells based on the sensor information.

6. The monitoring system according to claim 2, wherein
the controller executes the image recognition processing on the selected monitoring image corresponding to the detected process in which the dwelling is detected among the plurality of monitoring images, and
the controller does not execute the image recognition processing on the unselected monitoring image corresponding to an undetected process in which the dwelling is not detected among the plurality of monitoring images.

7. The monitoring system according to claim 2, wherein
the controller selects, each as the input for the image recognition processing, the monitoring image corresponding to the detected process in which the dwelling is detected and monitoring images corresponding to preceding process and subsequent process of the detected process from among the plurality of monitoring images.

8. The monitoring system according to claim 1, wherein
the controller specifies a process that is a factor of delay of the work process in the plurality of processes based on the status of each process recognized by the image recognition processing.

9. The monitoring system according to claim 7, wherein
the controller specifies a process that is a factor of delay of the work process in the plurality of processes based on a combination of the status of the detected process in which the dwelling is detected and respective statuses of the preceding process and subsequent process of the detected process.

10. The monitoring system according to claim 1, further comprising an output circuit that outputs information,
wherein the controller causes the output circuit to output information to identify the selected monitoring image from among the plurality of monitoring images.

11. The monitoring system according to claim 1, wherein
the at least one camera includes a plurality of cameras, and
the plurality of monitoring images is captured by the plurality of cameras.

12. The monitoring system according to claim 1, wherein
the image recognition processing recognizes an action of a worker in the work process as the status of each process.

13. A monitoring method for monitoring, with at least one camera, a work process including a plurality of processes performed on an object, the monitoring method comprising:
acquiring, with a computer, image data indicating each of a plurality of monitoring images obtained by capturing the plurality of processes with the at least one camera; and
executing, with a controller of the computer, image recognition processing to recognize a status of each process in the work process based on the image data,
wherein in executing the image recognition processing, the controller:
selects a monitoring image as an input for the image recognition processing from among the plurality of monitoring images based on sensor information indicating a detection result of the object in the work process; and
executes the image recognition processing on the selected monitoring image from among the plurality of monitoring images without executing the image recognition processing on an unselected monitoring image from among the plurality of monitoring images.

14. A tangible non-transitory computer readable medium storing a program for causing a controller of a computer to execute the monitoring method according to claim 13.
